(19) United States
(12) Patent Application Publication
(10) Pub. No.: US 2006/0083479 A1
(43) Pub. Date: Apr. 20, 2006

(54) Portable recording and reproducing apparatus, recording and reproducing system, and recording and reproducing method

(75) Inventors: Masao Iwasaki, Fuchu-shi (JP); Toshihiro Morohoshi, Kawasaki-shi (JP); Hidehito Izawa, Hanno-shi (JP); Kazuhiro Takashima, Tokyo (JP); Hitoshi Suzuki, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/241,923

(22) Filed: Oct. 4, 2005

(30) Foreign Application Priority Data
Oct. 14, 2004 (JP) 2004-300316

(51) Int. Cl. H04N 5/76; H04N 5/781

(52) U.S. Cl. 386/46; 386/125

(57) ABSTRACT

A portable recording and reproducing apparatus has a communication unit configured to make communication with an external device, a recording unit configured to record contents information, a display unit configured to display image information, and a controller configured to notify image size information displayable on the display unit via the communication unit to the external device, to make an instruction of transferring desired contents information and image information associated therewith, to record the contents information and the image information in the recording unit when receiving the same, and further to display the associated image information on the display unit while reading and reproducing it.

### CROSS-REFERENCE TO RELATED APPLICATIONS

This application is based upon and claims the benefit of priority from prior Japanese Patent Application No. 2004-300316, filed Oct. 14, 2004, the entire contents of which are incorporated herein by reference.

### BACKGROUND OF THE INVENTION

1. Field of the Invention

The present invention relates to a portable recording and reproducing apparatus, and particularly to a portable recording and reproducing apparatus using image information, a recording and reproducing system and a recording and reproducing method.

2. Description of the Related Art

Audio information and the like have been generally processed with digital data in recent years, and particularly portable recording and reproducing apparatuses have been manufactured and widely used. In such portable recording and reproducing apparatuses, since people can easily listen to music and operate audio information on a file basis, access performance has been increasingly improved as compared with conventional apparatuses. In a portable audio apparatus, however, there is a need that he/she wants to enjoy not only the audio information but also images associated therewith.

Jpn. Pat. Appln. KOKAI Publication No. 2002-123273 discloses an information terminal apparatus capable of reproducing audio information and additionally displaying image information associated therewith.

In the apparatus according Jpn. Pat. Appln. KOKAI Publication No. 2002-123273, however, nothing is not shown as to how to prepare image information for a relatively small screen in the portable audio apparatus while how to display an image is shown. Therefore, there is a problem that image information is too large to be well displayed on a display in the portable audio apparatus or requires much time to display.

### BRIEF SUMMARY OF THE INVENTION

There is provided a portable recording and reproducing apparatus comprising: a communication unit configured to make communication with an external device; a recording unit configured to record contents information in a recording area; a display unit configured to display image information; and a controller configured to notify image size information displayable on the display unit to the external device via the communication unit, to make an instruction of transferring desired contents information and image information associated therewith, to record the contents information and the image information in the recording unit on receiving the same, and further to display the associated image information on the display unit while reading and reproducing the same.

### BRIEF DESCRIPTION OF THE SEVERAL VIEWS OF THE DRAWING

FIG. 1 is a block diagram showing one example of a structure between a portable recording and reproducing apparatus according to one embodiment of the present invention and a PC;

FIG. 2 is an appearance view showing one example of the portable recording and reproducing apparatus according to the embodiment of the invention and the PC;

FIG. 3 is a block diagram showing one example of a structure among the portable recording and reproducing apparatus according to the embodiment of the invention, a cradle and the PC;

FIG. 4 is an appearance view showing another example of the structure among the portable recording and reproducing apparatus according to the embodiment of the invention, the cradle and the PC;

FIG. 5A is a diagram showing one example of a data format of audio information in the portable recording and reproducing apparatus according to the embodiment of the invention;

FIG. 5B is a diagram showing one example of a data format of audio information in the portable recording and reproducing apparatus according to the embodiment of the invention;

FIG. 6 is a flowchart showing one example of a processing of transferring image files for the portable recording and reproducing apparatus according to the embodiment of the invention;

FIG. 7 is a flowchart showing one example of the processing of transferring image files for the portable recording and reproducing apparatus according to the embodiment of the invention; and

FIG. 8 is a flowchart showing one example of the processing of transferring image files for the portable recording and reproducing apparatus according to the embodiment of the invention.

### DETAILED DESCRIPTION OF THE INVENTION

One embodiment according to the present invention will be described below in detail with reference to the drawings.

<Recording and Reproducing Apparatus According to One Embodiment of the Present Invention>

A recording and reproducing apparatus according to the embodiment of the invention will be described below in detail with reference to the drawings.

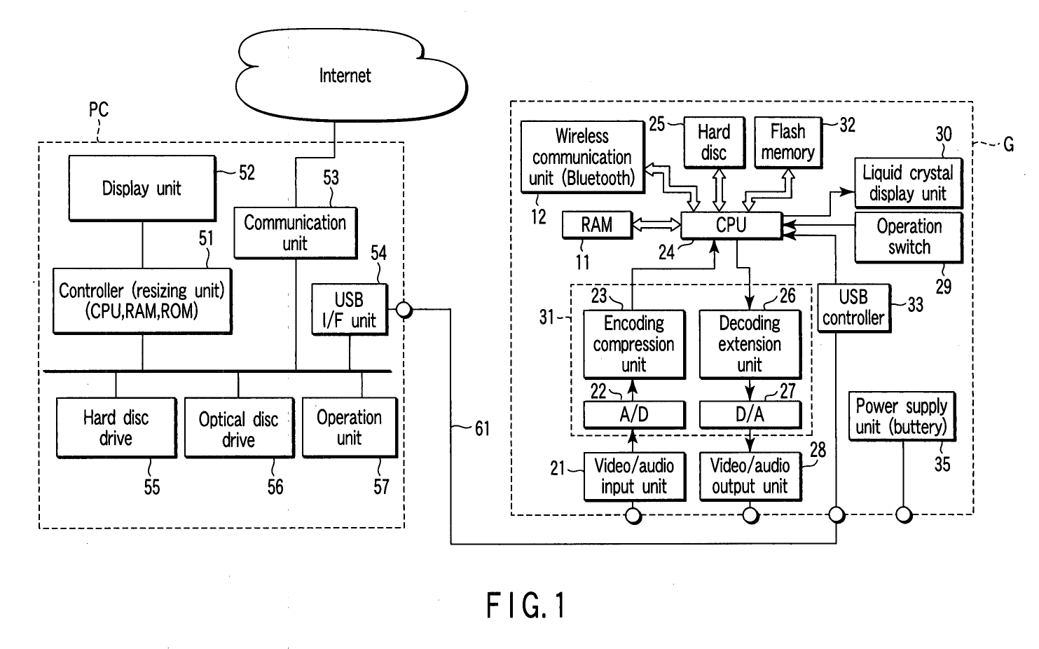

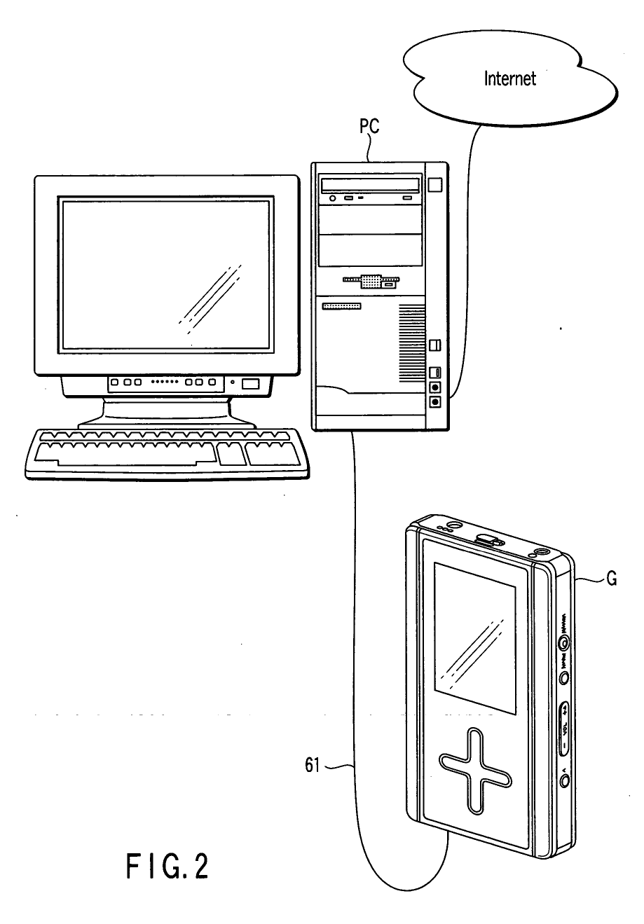

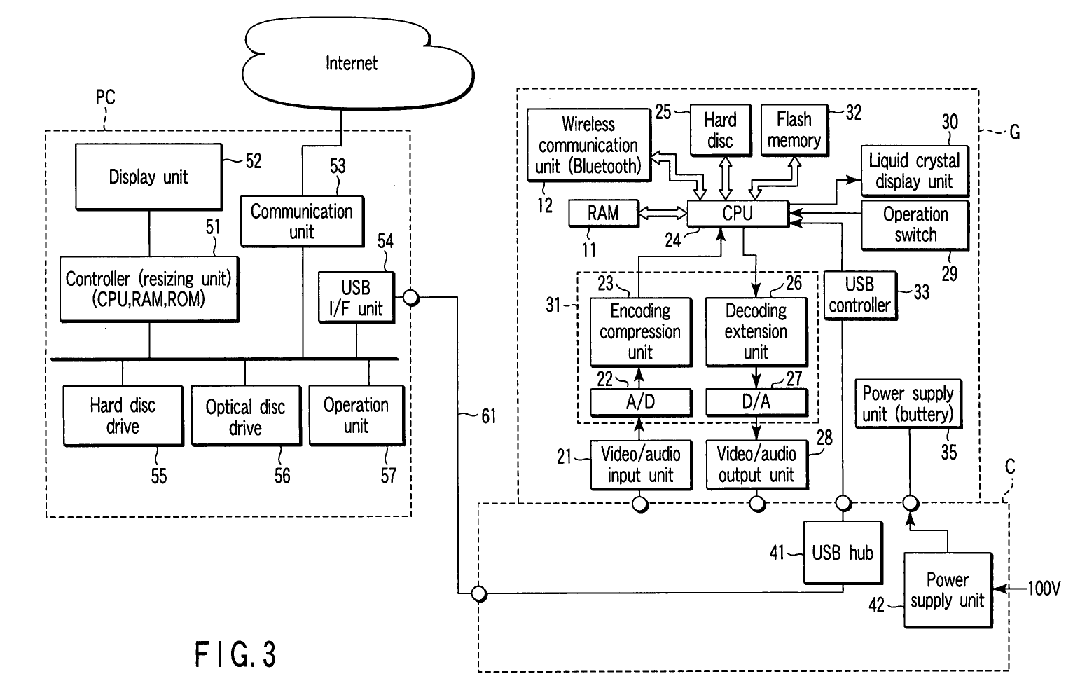

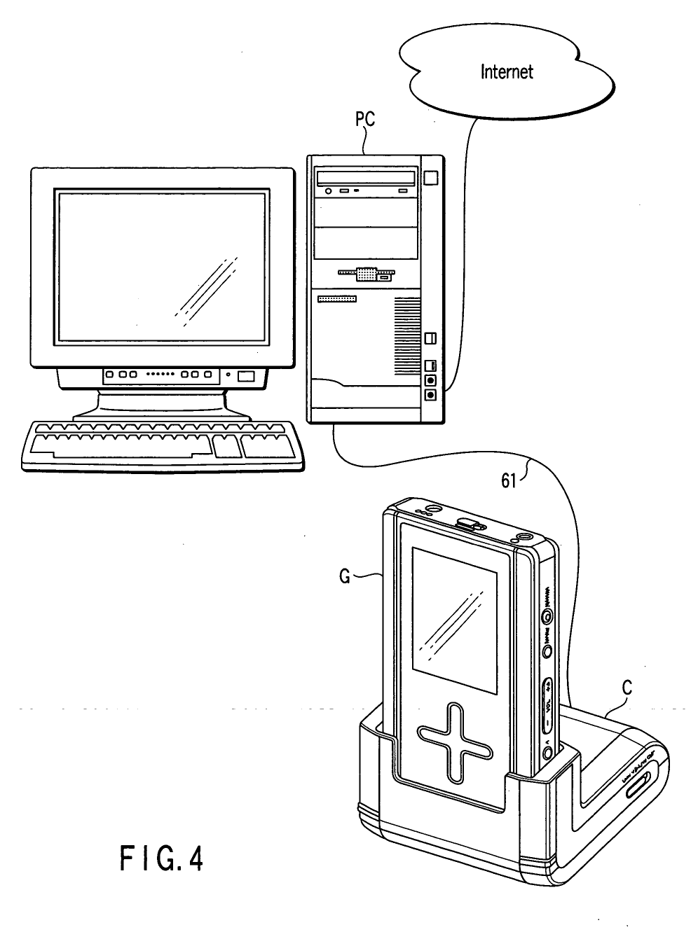

FIG. 1 is a block diagram showing one example of a structure between a portable recording and reproducing apparatus according to the embodiment of the invention and a PC. FIG. 2 is an appearance view showing one example of the portable recording and reproducing apparatus and the PC. FIG. 3 is a block diagram showing one example of a structure among the portable recording and reproducing apparatus, a cradle and the PC. FIG. 4 is an appearance view showing another example of the structure among the portable recording and reproducing apparatus, the cradle and the PC.

A recording and reproducing apparatus G according to the embodiment of the invention includes, in FIGS. 1 to 4, a video/audio processing integrated device 31 connected to a video/audio input unit 21 and a video/audio output unit 28, a CPU 24 connected thereto serving as a central processing unit and a controller, a RAM 11 connected thereto serving as a storage area, a hard disc 25 similarly connected to the CPU 24, a flash memory 32 similarly connected to the CPU 24 serving as an incorporated storage area, an enciphering unit 40 for performing encipher processing on contents information, a liquid crystal display unit 30 similarly connected to the CPU 24 for displaying operation information and the like, an operation switch 29 similarly connected to the CPU 24, a USB controller 33, a USB terminal 37, and a power supply unit 35. The flash memory 32 may be a SD memory card or a recording medium capable of reading and writing data in a PC card or the like. Other interface such as I-Link may be employed instead of the USB terminal.

The microprocessor 24 is connected with the operation switch 29 having operation input switches for audio recording, video recording, audio/video reproducing, operation power supply OFF and the like in the portable recording and reproducing apparatus G, and the liquid crystal display unit 30 for indicating an operation status of the portable recording and reproducing apparatus G in response to an input from the operation switch 29. The liquid crystal display unit 30 displays GUI (graphic user interface) such as a menu screen when the portable recording and reproducing apparatus G is operated.

Further, an A/D circuit 22, an encoding compression circuit 23, a decoding extension circuit 26 and a D/A circuit 27 are constituted of the one-chip video/audio processing integrated device (referred to as the video/audio processing IC below) 31.

The portable recording and reproducing apparatus G further includes a wireless communication unit 12 as a short-distance wireless communication interface such as Bluetooth connected to the CPU 24. The Bluetooth is a short-distance wireless communication interface standard within about 10 m, whose maximum communication speed is 1 M bit per second and which uses a frequency of 2.4 GHz band as in the IEEE802.11b type wireless LAN.

The wireless communication unit 12 is not limited to Bluetooth and may employ a similar short-distance wireless communication. For example, the wireless communication unit 12 may suitably employ UWB standard, infrared communication standard, wireless LAN (IEEE802.11b) standard and the like, but is not limited thereto.

The cradle C as the power supply device includes, in FIGS. 3 and 4, a USB hub 41 connected to the USB terminal 37. The cradle C further includes a power supply unit 42 which converts household alternating current AC 100V into, for example, direct current DC 12V and supplies the direct current to a power supply unit (buttery) 35 in the portable recording and reproducing apparatus G via a power supply input terminal.

The portable recording and reproducing apparatus G according to the present invention is, as shown in FIGS. 1 to 3, connected to a personal computer PC through a USB cable 61 or the like via the cradle C. The personal computer PC as an external device (relative to the portable recording and reproducing apparatus G) storing therein contents information includes, as one example, a controller 51 having a CPU, a RAM storing therein various operation programs, a ROM and the like, a display unit 52 such as a liquid crystal display via a data bus, a hard disc drive 55 storing therein contents information such as audio information, an optical disc drive 56 such as a compact disc (CD) or a digital versatile disc (DVD), an operation unit 57 such as a keyboard, an I/F unit 54 such as USB, and a communication unit 53 communicable to the Internet such as Ethernet, and suitably includes a wireless LAN I/F unit 58 such as IEEE802.11b as shown in FIG. 4.

The portable recording and reproducing apparatus G according to the present invention performs reproduction processing as follows based on the above structure. In the portable recording and reproducing apparatus G, in response to an operation mode given as a basic initial setting, according to operation information given from the operation switch 29, under control of the microprocessor 24, digital encoding compression data read from the hard disc 25 or the incorporated flash memory 32 is subjected to data extension in the decoding extension circuit 26 to be decoded and converted into a digital video/audio signal. The digital video/audio signal generated in the decoding extension circuit 26 is converted into an analog video/audio signal in the digital/analog conversion circuit (referred to as D/A circuit below) 27 and is supplied to the video/audio output circuit 28 constituted of an amplifier circuit and a speaker or display so that the reproduction processing is performed.

The portable recording and reproducing apparatus G as the recording and reproducing apparatus according to the present invention performs record processing in response to the operation mode given as the basic initial setting. In other words, according to the operation information given from the operation switch 29, digital contents information acquired via the USB terminal 37 (or the video/audio input unit 21 or the like) (analog contents information in the case of via the video/audio input unit 21) is, for example, enciphered in the enciphering unit 40 to be recorded in the hard disc 25 or the flash memory 32. The operation information in the processing is given through user's operation from the operation switch 29 (including remote controller) provided in the portable recording and reproducing apparatus G, but it may be given from the cradle or PC and the like via the USB terminal 45 or the wireless communication unit 12 as described later.

The portable recording and reproducing apparatus G as the recording and reproducing apparatus according to the present invention performs reproduction processing in response to the operation mode given as the basic initial setting. In other words, according to the operation information given from the operation switch 29, edition processing and the like can be performed on the digital data read from the hard disc 25 or the incorporated flash memory 32. The operation information in these processes is given through user's operation from the operation switch 29 (including remote controller) provided in the portable recording and reproducing apparatus G, but it may be given from the cradle or PC via the USB terminal 54 or the wireless communication unit 12 as described later.

<Process of Transferring and Displaying Image Information>

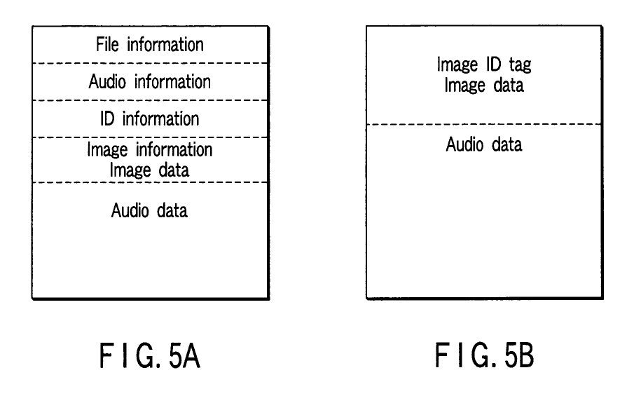

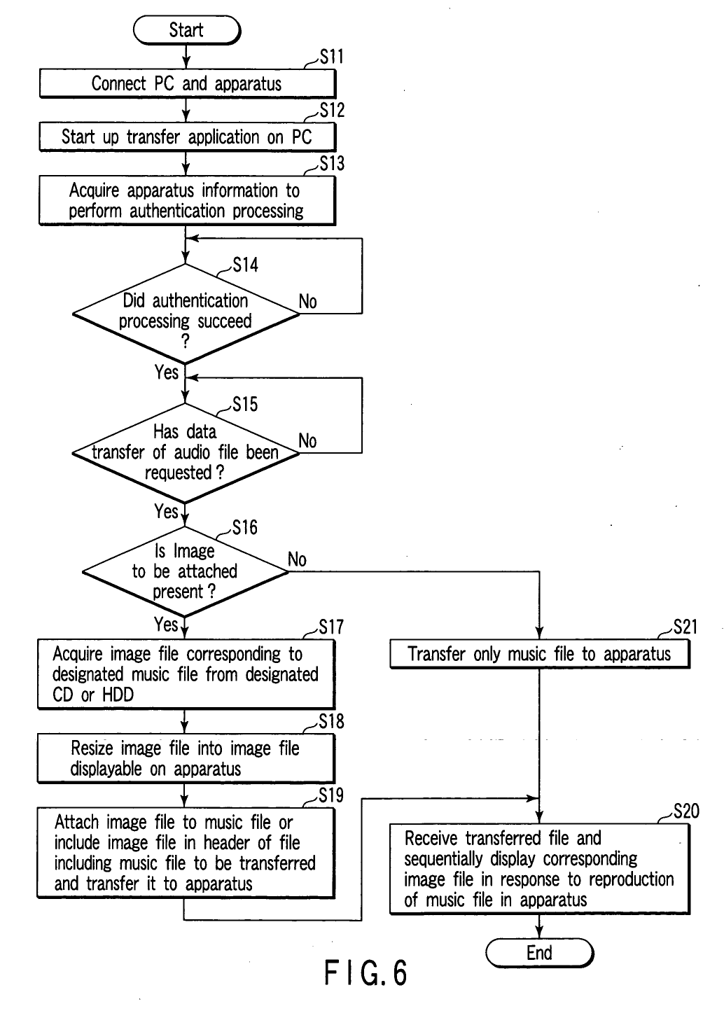

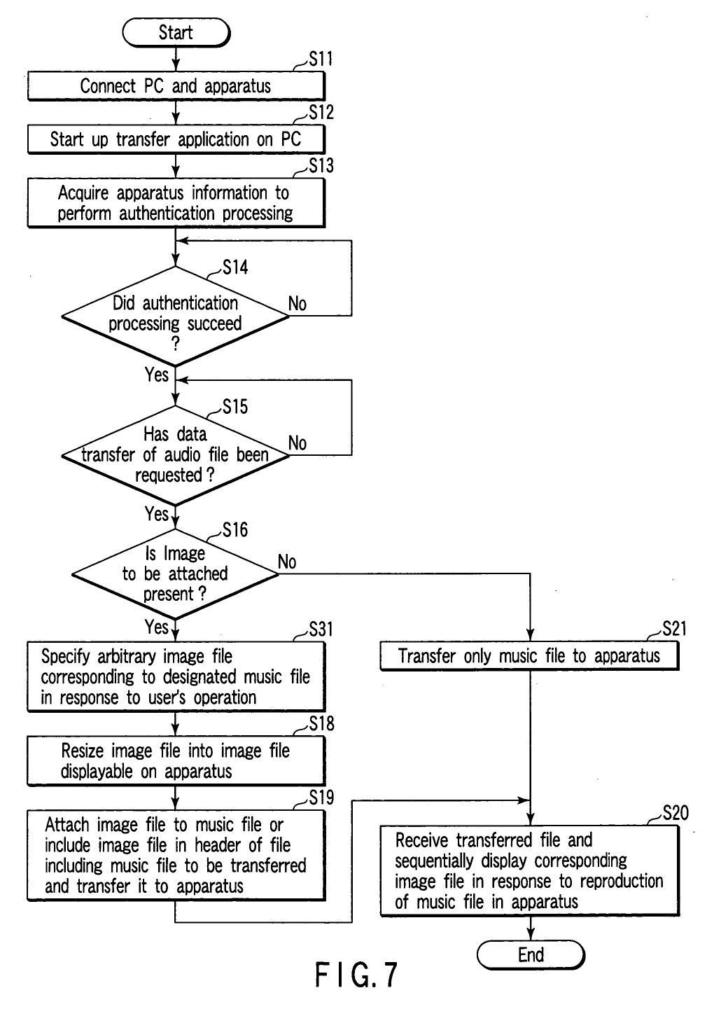

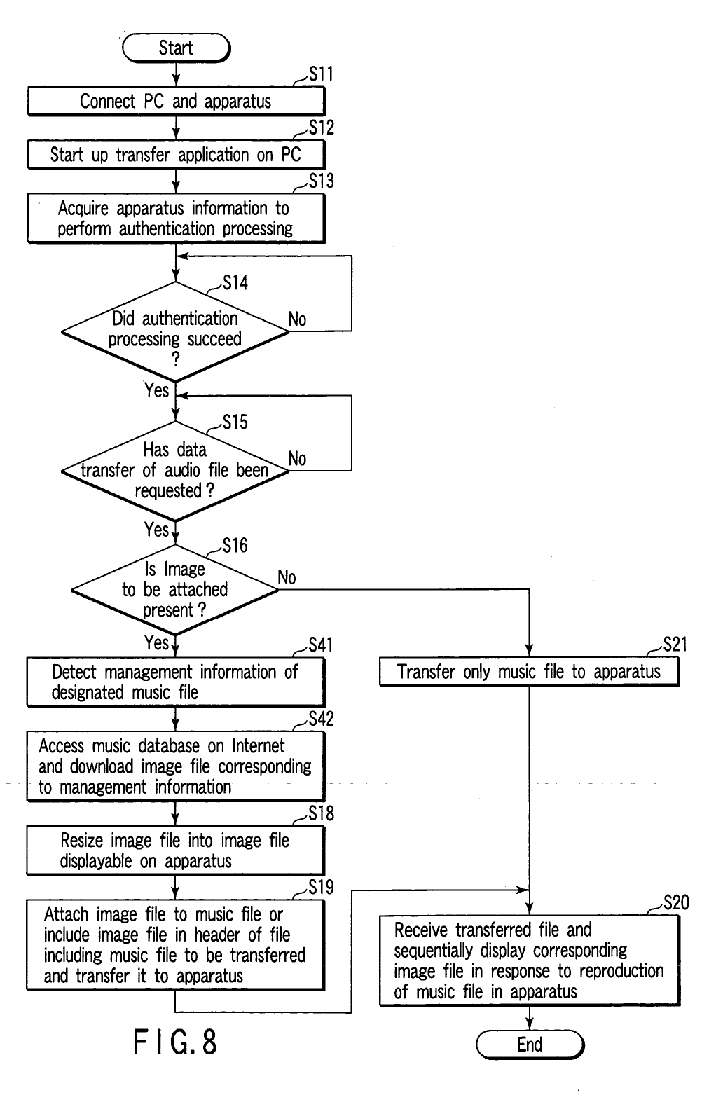

Next, processings of transferring and displaying image information associated with content information and associated information thereof will be described using flowcharts and the like. FIGS. 5A and 5B are diagrams showing one example of a data format of audio information in the portable recording and reproducing apparatus according to the embodiment of the invention. FIG. 6 is a flowchart showing one example of a processing of transferring image files for the portable recording and reproducing apparatus. FIG. 7 is a flowchart showing one example of the processing of transferring image files for the portable recording and reproducing apparatus. FIG. 8 is a flowchart showing one example of the processing of transferring image files for the portable recording and reproducing apparatus.

The portable recording and reproducing apparatus G according to the present invention and the personal computer PC connected thereto transfer and display content information (audio information) and image information associated therewith on the display unit such as a liquid crystal screen.

In the portable recording and reproducing apparatus G and the personal computer PC, as shown in the block diagrams in FIGS. 1 to 4 and the flowchart in FIG. 6, the portable recording and reproducing apparatus G and the personal computer PC are initially connected via, for example, the USB cable 61 or the like (S11). Then a transfer application on the personal computer PC is started up (S12). In this state, the transfer application on the personal computer PC acquires identification information from the portable recording and reproducing apparatus G connected thereto and performs authentication processing (S13). If the authentication processing is successful (S14), a file status in the recording medium in the portable recording and reproducing apparatus G can be observed from the application on the personal computer PC. During the authentication processing or after the successful authentication processing, image size information on the image information displayable on the display unit 30 in the portable recording and reproducing apparatus G is preferably transferred to the personal computer PC via the USB cable or the like. The image size information, however, may be transferred on the next transfer request.

The image size information is preferably, as one example, 320×240 pixels, 160×120 pixels, 75×75 pixels and the like, but is not limited thereto and may be set at any value depending on the specification of the display unit 30.

When a data transfer of contents information, here, audio information is requested in response to user's operation from the operation switch 29 or the like in the portable recording and reproducing apparatus G (S15), a determination is further made as to whether the image information to be attached to the audio information is present in a predetermined area in, for example, the CD drive 56 or the hard disc drive 55 in the personal computer PC (S16) (if the image information to be attached is not present, only the audio information is transferred to the portable recording and reproducing apparatus G (S21)).

This determination preferably employs a method of retrieving image information which has the same name as the designated audio information and is different only in an extension in the same folder or image folder and, if it is present, determining that it is the corresponding image information (S17). When there is prepared a mechanism where an image is stored in a header of the audio information to be transferred, it is confirmed whether the image information is already present in the header. Since the folder only for image storage is typically managed by the OS (operating system), a specific API command is issued to the OS to perform confirmation.

Next, when association between the audio information and the image information is supported by the OS, it is preferable that the API command is issued to the OS to confirm whether the associated image information is present.

As shown in step S31 in FIG. 7, a method of assigning arbitrary desired image information in correspondence to the audio information each time in response to user's operation on the screen of the transfer application to designate image information is also preferable.

As shown in step S41 in FIG. 8, a method of detecting management information on the user-designated audio information and then retrieving an image corresponding to the management information in the CD drive 56 or hard disc, if the image is retrieved, assume it as the target image is also preferable. It is preferable to access a music database on the Internet via the communication unit 53 in FIG. 1 based on this management information, to detect the image file corresponding to the management information and to download it (S42). It is also preferable to download the image information and associated information such as lyrics information, artist information and album created-year on the audio information according to the management information and to transmit the same as the associated information to the portable recording and reproducing apparatus G.

The assignment of the audio information and the image information has been described assuming that one item of audio information and one item of image information are assigned, but one or several items of image information may be assigned to, for example, a folder or classification category.

When a folder is created for each album and files corresponding to tracks are stored therein, people wants to assign an album jacket's photograph to the folder. Since the folder is prescribed in its structure by the file system of the OS, it is difficult to add image information thereto. In such a case, a rule of using the same image information name as the folder name is created and managed. Creation of a database for prescribing the association enables to associate the folder with the image information. Thus, it is possible to detect one folder storing therein several items of audio information and the image information corresponding to the folder in response to the transfer instruction, to attach the same to the audio information, and to transmit the same to the portable recording and reproducing apparatus G via the communication unit. It is preferable that the audio information is collectively treated in a predetermined range such as a group, not limited to the folder, and the associated information such as the image information corresponded thereto is detected.

Resizing of Image Information

Next, the image detected in this manner is resized according to the given image size information (S18). In other words, since the image information is data photographed by a digital camera, the image size is as large as horizontal 2048 pixels and vertical 1536 pixels in many cases. However, the size displayable on the LCD display unit mounted on the portable recording and reproducing apparatus G is significantly smaller than it. In this embodiment, when the image information is transferred from the PC, it is converted into a size easily displayable on the portable recording and reproducing apparatus G to be transferred, thereby quickly displaying the image on the portable recording and reproducing apparatus G.

The image size information displayable on the display unit 30 in the portable recording and reproducing apparatus G is, for example, acquired in the authentication processing in step S13, but may be notified when a request of transferring audio information is occurred.

The image size conversion is preferably performed in attaching an image file. For example, when the size displayable on the LCD display unit 30 is horizontal 320 pixels and vertical 240 pixels, the image size is converted from 2048×1536 pixels into 320×240 pixels. Further, the size may be as small as 160×120 pixels or 75×75 pixels, but it is not limited thereto.

The image size conversion eliminates the need of the processing of decoding an image once and performing size conversion into a displayable size when displaying the image on the portable recording and reproducing apparatus G, thereby quickly displaying the image information.

When the number of bits is as small as 8 bits or 16 bits on the LCD display relative to the original image of 24 bits, a color reduction processing is simultaneously performed, thereby reducing a display time. Further, conversion in a scanning direction (from top to bottom or from bottom to top) or point sequential and face sequential conversions are preferably performed as needed.

When the image size or display form to be displayed is different depending on a screen mode of the device (for example, monochrome, vertical/horizontal inversion, white/black inversion), image specifications required for the respective display modes are listed, and image information suitable thereto is preferably created.

Attachment to Header

The image information which has been resized and has been appropriately subjected to image processing (not limited to the image information, including associated information such as lyrics information or artist information described above) is transmitted to the portable recording and reproducing apparatus G together with the audio information, and the audio information is encoded and transferred in order to protect the copyright of the audio information.

The image information is simply transferred in correspondence to the audio information, and further it is preferably attached to the header to be transmitted as shown in FIG. 5A. In other words, when the image information (or associated information) associated with the audio information is present, the image information and the like are attached to the audio information.

In other words, FIG. 5A shows a copyrighted data format, where information such as file information, audio information, ID information and image information is attached to the header of the ordinary audio information and alternatively the audio information is enciphered.

The file information describes therein character strings or time stamp information of a file pass, for example. The audio data describes therein information such as audio format, sampling frequency, bit rate, the number of channels, reproduction time, song titles, artist's name and album title.

The ID information describes therein information such as a unique ID used for protecting the copyright of the audio information. The image information/image data describes therein image information associated with the audio information. The image information is an image information format displayable on the PC such as JPG/GIF/BMP, and is, for example, lyric information or artist-associated information.

When the copyright of the audio information does not require protecting, as shown in FIG. 5B, the image information may be preferably attached to an ID tag in the data format of the audio information. For example, when the audio information's format is MP3, the image information is attached to an image frame tag of MP3IDv2.

Although the image information or the like is arranged on the header of the file in this example, it is also possible to divide the information into another file and store its file name into the header instead of the image file.

In this manner, the image information or the like (including associated information) is transferred from the personal computer PC to the portable recording and reproducing apparatus G together with the audio information to make one file, so that the audio information and the image information do not require to associate separately. Further, even when the data is moved within the recording medium after being transferred to the portable recording and reproducing apparatus G, the image information is present together, which avoids a risk of losing relationship between the audio information and the image information within the recording medium.

In this manner, the image information is attached to the audio information or the image information is included in the header of the file to be transferred including the audio information so that it is transferred to the portable recording and reproducing apparatus G (S19).

Reproducing Method

Thereafter, the portable recording and reproducing apparatus G receives the audio information and the associated information of the image information via a communication path such as USB cable 61 (or via the USB hub 41 in the cradle C as shown in FIG. 3). The portable recording and reproducing apparatus G decodes the audio information and the associated information of the image information to record the same in the hard disc 25 or the like if encoded. Further, it may preferably encipher the information in the enciphering unit (not shown) to record.

When the audio information (file) is reproduced in response to user's operation, the associated image information is read from the hard disc 25 or the like to be displayed on the display unit 30. When one item of image information corresponds to one item of audio information (file), it is preferable that the corresponding image information is sequentially updated and displayed in response to the reproduction of the audio information (file). Further, one item of image information may continue to be displayed for several items of audio information. Further, it is preferable that several items of image information are sequentially changed over and reproduced for one item of audio information (file) on a time basis.

The lyric information is also preferably displayed in addition to the image information according to the audio information (file). In this case, it is preferable that the image information and the lyric information are changed with the operation switch 29 or the like to be arbitrarily displayed.

As described above in detail, in the portable recording and reproducing apparatus, an instruction of transferring not only the contents information such as audio information but also the image information associated therewith is made to the personal computer connected via the USB or the like, an artist's portrait image corresponding to the album of a specific artist is displayed on the LCD (Liquid Crystal Display) or the like. At this time, the image size information to be displayed on the display unit is preferably transmitted from the portable recording and reproducing apparatus to the personal computer. Alternatively, the image size information is previously given to an application for image transmission on the personal computer. Thus, the personal computer can reduce the image information corresponding to the content information in keeping with the image size information in response to the transfer instruction to transmit it to the portable recording and reproducing apparatus.

As described above, according to the portable recording and reproducing apparatus of the present invention, for example, music is reproduced by the audio information and additionally the artist's image, the lyrics and the like are quickly displayed on the liquid crystal screen, thereby visual-comfortably operating while listening to the music.

Those skilled in the art can accomplish the invention according to various embodiments described above, and can readily devise various modifications to these embodiments and can apply them to various embodiments without inventive ability. For example, although description has been made mainly using the audio information as the contents information in the above embodiment, the embodiments according to the present invention are not limited thereto, and can be widely applied to video information and the like. Therefore, the present invention covers a wide range without departing from the disclosed principle and the novel features, and is not limited to the above embodiment.

What is claimed is:

1. A portable recording and reproducing apparatus comprising:
a communication unit configured to make communication with an external device;
a recording unit configured to record content information in a recording area;
a display unit configured to display image information; and
a controller configured to notify image size information displayable on the display unit to the external device via the communication unit, to make an instruction of transferring desired contents information and image information associated therewith, to record the contents information and the image information in the recording unit on receiving the same, and further to display the associated image information on the display unit while reading and reproducing the same.

2. A portable recording and reproducing apparatus according to claim 1, wherein on performing an authentication processing for the external device, the controller transmits the image size information displayable on the display unit to the external device.

3. A portable recording and reproducing apparatus according to claim 1, wherein on receiving the contents information from the external device, the controller controls to extract the image information from a header of the contents information and to display the extracted image information on the display unit.

4. A portable recording and reproducing apparatus according to claim 1, wherein on performing an authentication processing for the external device, the controller transmits any one of 320×240 pixels, 160×120 pixels and 75×75 pixels as image size information displayable on the display unit.

5. A portable recording and reproducing apparatus according to claim 1, wherein on receiving several items of the contents information and image information associated therewith from the external device, the controller sequentially displays several items of image information while associating the same in response to reproduction of the several items of contents information.

6. A portable recording and reproducing apparatus according to claim 1, wherein on receiving a group of the several items of contents information and one item of image information corresponding to the group from the external device, the controller displays the one item of image information corresponding to the group while reproducing the several items of contents information in the group.

7. A portable recording and reproducing apparatus according to claim 1, wherein the controller requests the contents information as well as image information and lyrics information corresponding thereto to the external device, and when receiving the contents information, the image information and the lyrics information, displays the image information or the lyrics information on the display unit while reproducing the contents information.

8. A portable recording and reproducing apparatus according to claim 1, wherein the controller changes over a display between the image information and the lyrics information on the display unit in response to user's instruction.

9. A recording and reproducing system comprising a recording apparatus and a portable recording and reproducing apparatus communicable therewith,
wherein the recording apparatus comprises:
a first recording unit configured to record contents information and image information associated therewith;
a first communication unit configured to make communication with the portable recording and reproducing apparatus; and
a first controller configured to, when the first communication unit receives a transfer instruction, read contents information and image information associated therewith from the first recording unit in response to the instruction, and to reduce the image information based on given image size information and then transfer the same together with the contents information via the first communication unit, and
the portable recording and reproducing apparatus comprises:
a second communication unit configured to make communication with the first communication unit in the recording apparatus;
a second recording unit configured to record the content information in a recording area;
a display unit configured to display the image information; and
a second controller configured to notify the image size information, to make an instruction of transferring desired contents information and image information associated therewith via the second communication unit to the recording apparatus, to record the contents information and the image information in the recording unit when receiving the same via the second communication unit, and further to display the associated image information on the display unit while reading and reproducing the same.

10. A recording and reproducing system according to claim 9, wherein the portable recording and reproducing apparatus transmits the image size information displayable on the display unit to the external device on an authentication processing for the recording apparatus.

11. A recording and reproducing system according to claim 9, wherein on receiving the transfer instruction, the recording apparatus attaches the image information to a header of the contents information to transmit it to the portable recording and reproducing apparatus.

12. A recording and reproducing system according to claim 9, wherein on receiving the transfer instruction, the recording apparatus retrieves image information which has the same name as the contents information and is different only in an extension in the same folder or image folder to specify the image information, and transmits it to the portable recording and reproducing apparatus.

13. A recording and reproducing system according to claim 9, wherein on receiving the transfer instruction, the recording apparatus detects and attaches lyrics information corresponding to the contents information in addition to the contents information and image information associated therewith, and transmits the same to the portable recording and reproducing apparatus.

14. A recording and reproducing system according to claim 9, wherein on receiving the transfer instruction, the first controller in the recording apparatus detects management information of the contents information, uses a communication function to acquire management information or lyrics information based on the management information via the Internet, and attaches the same to the contents information to transmit it via the first communication unit to the portable recording and reproducing apparatus.

15. A recording and reproducing system according to claim 9, wherein the first controller in the recording apparatus detects one folder storing therein the several items of contents information and one item of image information corresponding to the folder in response to the transfer instruction and attaches the same to the contents information to transmit it via the first communication unit to the portable recording and reproducing apparatus.

16. A recording and reproducing system according to claim 9, wherein the first controller in the recording apparatus detects a group of the several items of contents information and one item of image information corresponding to the group in response to the transfer instruction, and attaches the same to the contents information to transmit it via the first communication unit to the portable recording and reproducing apparatus.

17. A recording and reproducing system according to claim 9, wherein the portable recording and reproducing apparatus comprises a power supply unit having a charging function, and further the recording and reproducing system stores therein the mainbody of the portable recording and reproducing apparatus and comprises a power supply device configured to supply power to the power supply unit, and
the recording apparatus and the portable recording and reproducing apparatus make communication via a communication path which the power supply device has in its mainbody.

18. A recording and reproducing method of a recording and reproducing system comprising:
a recording apparatus having a first recording unit configured to record contents information and image information associated therewith and a first communication unit configured to make communication with the portable recording and reproducing apparatus; and
the portable recording and reproducing apparatus having a second communication unit configured to make communication with the first communication unit in the recording apparatus, a second recording unit configured to record the contents information in a recording area, and a display unit configured to display the image information,
wherein the portable recording and reproducing apparatus notifies image size information displayable on the display unit, and instructs to transfer desired contents information and image information associated therewith via the second communication unit to the recording apparatus,
when the first communication unit receives a transfer instruction, the recording apparatus reads contents information and image information associated therewith from the first recording unit in response to the instruction, and reduces the same based on the image size information to transfer it together with the contents information via the first communication unit to the portable recording and reproducing apparatus, and
on receiving the content information and the image information via the second communication unit, the portable recording and reproducing apparatus controls to record the same in the recording unit and further to display the associated image information on the display unit while reading and reproducing the same.

19. A recording and reproducing method according to claim 18, wherein on an authentication processing for the recording apparatus or after the authentication processing, the portable recording and reproducing apparatus transmits the image size information displayable on the display unit to the external device.

20. A recording and reproducing method according to claim 18, wherein on receiving the transfer instruction, the recording apparatus attaches the image information to a header of the contents information to transmit it to the portable recording and reproducing apparatus.
